(19) United States
(12) Patent Application Publication
(10) Pub. No.: US 2012/0245754 A1
(43) Pub. Date: Sep. 27, 2012

(54) METHOD AND APPARATUS FOR ANALYSIS OF ENERGY INPUT DURING OPERATION OF A PRODUCTION SYSTEM

(76) Inventor: Jens Mehnert, Heinsdorfergrund (DE)

(21) Appl. No.: 13/513,962

(22) PCT Filed: Dec. 4, 2010
(86) PCT No.: PCT/DE10/01425

§ 371 Date: Jun. 5, 2012

(30) Foreign Application Priority Data
Dec. 5, 2009 (DE) 10 2009 057 143.4

(51) Int. Cl. G06F 1/26

(52) U.S. Cl. 700/297

(57) ABSTRACT

A method analyzes the energy use during an operation of a production system containing machines and supply equipment having an energy demand that can be determined and planning apparatuses for the work orders to be carried out by the machines. The energy-related parameters of the machines are determined and divided into representative load spectra by an energy control unit. Energy recovery values to be expected on average depending on the media are assigned to the load spectra. The respective time fractions of the load spectra for possible work orders and machine combinations are determined from the work orders to be carried, and the energy demand per machine for carrying out a work order is determined therefrom. A device is provided for performing the method.

The invention relates to a method and an apparatus for analysis of energy input and energy costs during operation of a production system by analysing the energy needs for the implementation of work orders to ensure the production environment in line with the supply equipment as well as with following multi-step optimisation of relevant parameters.

More recently, there has been a growing demand for systems that help to reduce the energy consumption and the energy costs in production systems. Thus it has long been known that electricity meters could be provided which detect the energy consumption of an entire system. Current measuring devices have the disadvantage, however, that they do not refer to the actual process, the environmental conditions or current time-related of use of electricity. An analysis of all the consumption devices which are energy-related in regards to the energy carrying medium used, the energy needs over time, a time and spatial relationship as well as an energy exchange between production equipment and building equipment, including a determination of appropriate energy storage or energy conversion equipment for excess amounts of energy, has not been completely carried out to date, or described in the form of a process description.

Layout planning for machines is usually supported by production planning and production control systems, which implement a layout planning of machines on the basis of backwards scheduling, whereby the top optimisation goal of the delivery schedule and further design criteria is the machine hour rate. The known technical solutions for this include most extensive basic and expansion options for the design of customised solutions. In addition, functions serve in service-oriented architecture for an achievement of optimal toothing of modules used. However, even in this respect, an involvement of parameters of energy consume in the process is not known.

WO 2006/090 132 A3 describes a process to assess the energy efficiency of buildings. Neither the production system found in the building, nor the energy exchange between building equipment and production equipment are considered.

DE 10 2007 062 058 A1 describes a procedure and a device to analyse the energy use of a machine. The core of this is the exact analysis of machines in order to be able to structure and improve them in regards to their energy use. Neither a consideration of energy consumers going beyond the operating of a machine nor a merged energetic consideration of machines and building equipment is made.

The object of the invention is to provide a method and an apparatus for the analysis of energy input and energy costs during operation of a production system.

The goal is achieved with a method according to claim 1, wherein advantageous embodiments are designated as sub-claims. In order to implement the method, an apparatus is proposed in accordance with claim 9.

In an inventive method for analysis of energy input and energy costs during operation of a production system, machines and supply equipment with a determinable energy demand and planning units for work orders to be implemented in the machines form the elements of the production system. The machines energy-related parameters, as the demand for powered drives, necessary media pressures and media flow rates as well as temperatures to be set are determined and assigned into representative load spectra by an energy control unit. Thus a “load spectrum” is seen as a class of operating states of a machine, and these operating states are characterised, in particular, by electrical power consumed by the associated flow rates, temperatures, pressures, speeds, currents and frequencies. Such load spectra form the foundation in order to later assign to them media-dependent average expected energy recovery values based on the respective elements.

The term “supply equipment” means, in the context of the present invention, in particular heating systems, systems for water heating, air conditioning equipment and compressed air systems.

The term “media-dependent” can be understood as follows in the context of the present invention: To operate machines, various media are used to provide or improve required functions. These can be classified as electricity, liquid or gaseous media. The medium of electricity is characterised by the parameters of voltage, current, power and frequency.

Liquid media are characterised by the parameters of pressure, volume flow, density and temperature. Within the scope of the invention, in addition, a consideration of a liquid substance in relation to its composition (addition of oils [for example, in cooling lubricants], fungicides [for example, in cooling lubricants, coolants for electrical drives], antifreeze [for example in respect to coolants for electric drives]), and its filter fineness (particle sizes graded from 0.1 mm to 10 μm) is made. Gaseous media are also characterised by the parameters of pressure, volume flow, density and temperature. Within the scope of the invention, in addition, one can consider the gaseous substance with respect to purity (composition), wherein oil mist-containing (e.g. machining area in a machine with cooling lubricants), particle-containing (e.g. machining area with a laser or burning machine for steel plate) or water mist-containing (e.g. machining area with a washing machine) are to be found. Thus, a media-dependent assessment of energy potential (see parameters) in the study area is not sufficient on its own. Only the composite picture provides information on technically feasible options for appropriate use of energy (heat exchange, heat storage, and reversibility of functions in terms of recovery).

A planning unit makes available the period-related work orders to be implemented. Thereafter, the respective time fractions of the load spectra can be determined periodically on this base for the work order and machine combinations, whereby the energy control unit can determine the energy needs of each appropriate machine to implement a work order.

It is suggested in an advantageous embodiment of the invention that the energy control unit stores the determined energy needs of each machine to implement a work order, and to form therefrom a priority order in the form of a preference graph according to energy consumption being calculated in each case.

Here, the term “preference graph” can be understood as follows in the context of the present invention: The prior art shows that at least two criteria are normally taken into account for defining the work space to implement a work order by a control unit. Thus the user as a rule can provide these criteria with weighting factors (for example 70% for meeting the delivery schedule, 30% for machine hours). The optimisation run of a ERP/PPS system occurring on this basic generates on this basis an assignment of jobs for a work order. This assignment may be designated as the preference graph (result of multi-criteria optimisation). The invention additionally includes the parameter “energy consumption”. Therefore, the result of optimisation, the preference graph, also includes the energy consumption in pooling machines to the process steps in the work order. The result will be a work plan as an operating document. A work plan describes the process of a product from raw material through various work processes and manufacturing equipment to a finished product. For each work process, the details of activities are specified in machines, and often extended with further organisational information, such as the estimated set-up times, cycle times, production cost centres and manufacturing facilities. It also names the work materials used and materials such as measurement materials, devices and special tools. In contrast to a parts list, which documents how a new part is made (as a general term for a single part, assembly and product), the work plan documents the steps to manufacture the product. The work plan and parts list are coupled in the sense that they are used for each operation of the work plan with the required raw materials, semi-finished products or components and their possible specifications in relation to the parts list.

The preference graph is transferred to a planning unit, which assesses the energy needs indicated in this way from the cost side and assigns, thereafter, the work orders to the machines, using the energy needs. There is a task to assign the work orders to the machine which has the smallest energy demand value compared to other machines. Further, the energy control unit provides the cost evaluation, including the next work order assignment, so only the values determined in this manner are transferred to the planning units of the production system.

In another embodiment of the method, the energy costs per period and medium are determined and the sequence of execution of the work orders is provided so that energy-intensive work orders are filed in periods with low energy costs.

Another advantageous embodiment provides that periods with energy-intensive work orders are determined by an energy control unit or a planning unit. Finally, a period-dependent energy cost adjustment is provided by the energy planning unit, and as a result, the energy control unit or planning unit makes the temporal order of execution of work orders in a way that the energy-intensive work orders are placed during periods of low energy costs.

The expected energy balance for each period for the machines and supply equipment as well as the predictable values for the energy needs for overcovered and undercovered periods are determined, and a media-dependent coupling structure of the machines among each other and of machines and supply equipment is determined therefrom. On this basis, there is an examination of whether, with the use of the determined combining structure, the expected values for energy consumption for relatively lower covered periods differ by more than five percent. When it is determined that there is a difference of more than five percent, additional media-specific energy storage units are determined and their classification relationship is tied in with minimal lengths for media transfers. Further, the energy control unit determines the energy needs depending upon outside temperature for supply for each medium and period as well as excess energy for each medium and period from the process sequence of the work orders for each machine, and a media-specific energy exchange is undertaken between the machines as well between the machines and the supply equipment in such a way that the overall energy needs of the production system is at a minimum.

It is further planned that the outside temperature dependent energy needs of the supply equipment for each medium and period as well as the excess energy for each medium and period is determined from the previously planned sequence of work orders for each machine, and this previously planned sequence of work orders is corrected in a way that the total energy needs of the production system is minimised.

The invented apparatus includes an energy control unit, which is connected to the elements of the production system, detects status data of these elements continuously and is connected with a planning unit and/or an energy planning unit. These connections take place wirelessly and/or via an internal network and/or the Internet. Also, the elements of the production system can be combined according to a scheme given from the energy control unit, and these connections can be separated by the energy control unit using shut-off means.

The advantage of the invention essentially consists in that an overall energy balance for the production system considering the respective implemented situation is created, and, by a multi-stage process flow, the energy required is first decreased, then shifted, subsequently stored and only then converted into another energy form. An integration of energetic consumption parameters in the scheduling for the sequencing of work orders to be processed, and in the planning guidelines for the shift assignment is done. These features, which are not present in currently-available ERP systems, enable the users for the first time to integrate energy consumption data in to the selection process for the determination of the workplace (what machine shall implement the work order) and subsequently a low-effort reduction of energy consumption and energy supply costs.

For implementation, the existing elements of the production system are to be connected in a beneficial way with one another preferentially. The invention may, for example, reduce energy consumption and energy supply costs for production systems in engineering or automobile industries.

In the following, an embodiment of the invention will be explained with reference to the drawing. It shows:

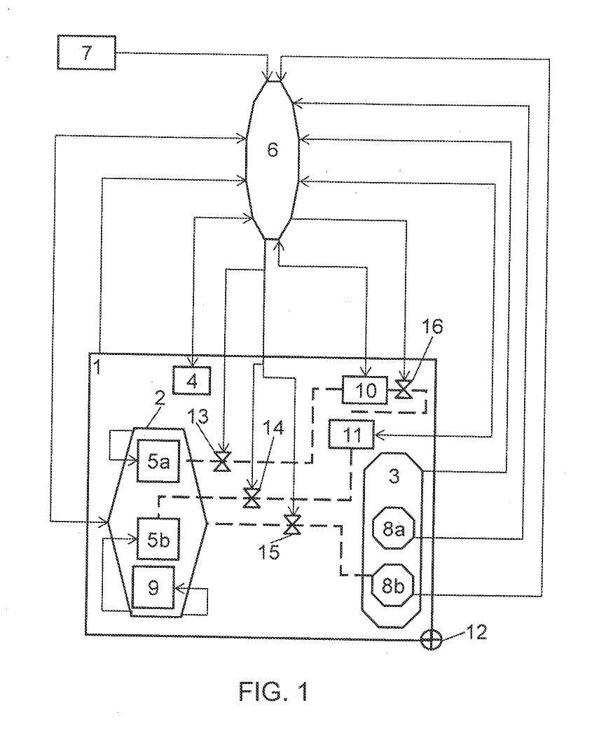

FIG. 1 a first embodiment of an apparatus for carrying out the invented method

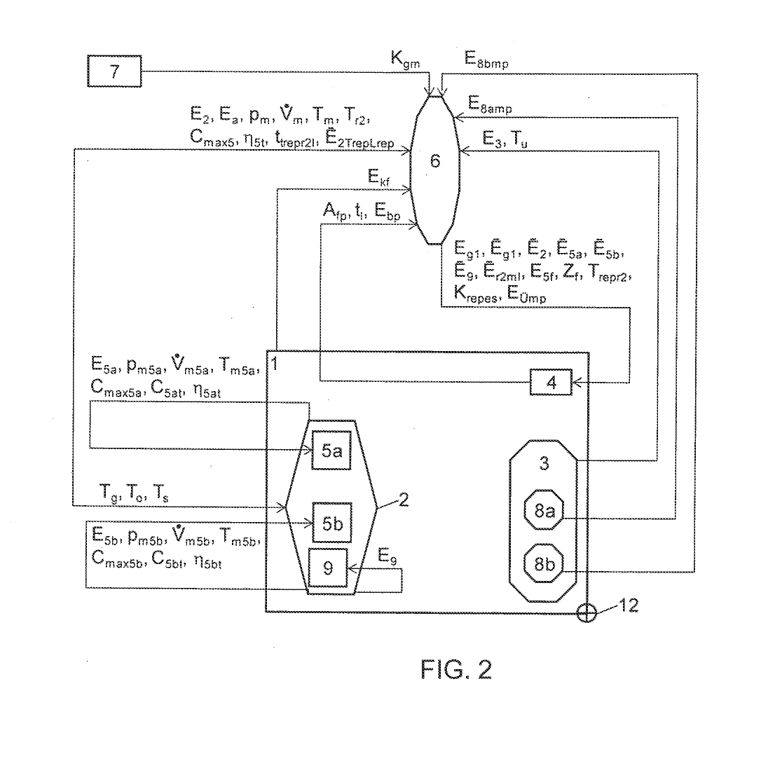

FIG. 2 the process of gathering, processing and outputting information between the elements of a production system in accordance with the preferred embodiment

FIG. 1 shows the exemplary structure of the apparatus in a first embodiment. Here, the thin lines drawn continuously show data or control lines, and the thick dashed lines are media lines.

The device relates to a production system 1, consisting of a machine 2 (e.g. a lathe), supply equipment 3 (for example, a heating system with an air curtain system at the hall doors), a planning unit 4, an energy storage unit 10 (for example, a hot water boiler) and an energy conversion unit 11 (for example, a heat pump).

The machine 2 comprises a temperature regulating device 5a and a temperature regulating device 5b and drive unit 9 (for example, an electric motor). The supply equipment 3 comprises a temperature regulating device 8a and a temperature regulating device 8b. The temperature regulating device 5a of the machine 2 is connected by a media line, into which the shut-off valve 13 is integrated, to an energy storage unit 10. The temperature regulating device 5b of the machine 2 is connected by a media line, into which the shut-off valve 14 is integrated, to an energy conversion unit 11. The machine 2 is connected through a media line, in which the shut-off valve 15 is integrated, with the temperature regulating device 8b of the supply equipment 3. The energy storage unit 10 is connected through a media line, in which the shut-off valve 16 is integrated, with the energy conversion unit 11. The reference point 12 is in the lower area of the production system 1. The energy control unit 6 is connected by means of data lines or control lines with the production system 1, the machine 2, the supply equipment 3, the planning unit 4, the temperature regulating device 8a and the temperature regulating device 8b of the supply equipment 3, the energy storage unit 10, the energy conversion unit 11, the energy planning unit 7 (e.g. the energy control equipment of a power plant) as well as the shut-off valves 13 to 16. The temperature regulating devices 5a and 5b as well as the drive unit 9 are connected to the non-shown control of the machine 2.

In FIG. 2, a preferred method is presented. After triggering a command to execute the invention-related method for analysis of the energy input as well as the energy costs when operating a production system 1 by an apparatus as described above, a machine 2, supply equipment 3 with a determinable energy need as well as a planning unit 4 provided to describe and optimise the work orders for machine 2 form the elements of the production system 1. Through the energy control unit 6, energy-relevant and adjustable parameters of the machine 2 are determined, such as the energy needs of the drive unit 9, the necessary media pressure or media volume flows as well as the temperatures to be set by the temperature regulating devices 5a and 5b, and classified into representative load spectra. These load spectra construct the basis afterwards in order to classify them media-dependently average expected energy recovery values. The planning unit 4 makes available the period-related work orders to be implemented. Finally, the time components of the load spectra can be determined based thereon periodically for the work order and machine combinations, whereby the energy control unit 6 can determine the energy needs of the machine 2 to implement a work order.

Through the next step in the procedure, representative working area temperatures of machine 2 are determined dependent upon the environmental temperature and including the respective use conditions, as well as lower and upper temperature limit values are given. On the basis of these representative work area temperatures, the respective temperature presettings are determined as the target values to be set by the temperature regulating devices 5a and 5b of the machine 2 in such a way that there is a minimum temperature difference between the environmental temperature and the work area temperature in the machine 2.

The next procedural step is characterised in such a way that the energy control unit 6 determines the required machine-specific energy needs when operating the production system 1 for frequently occurring load spectra until achieving the given representative work space temperature, depending upon the environmental temperature, as well as the average required machine-specific energy needs with achieved representative work space temperature for frequently occurring load spectra, and transferres them to the planning unit 4. From these machine-specific energy needs, then the planning unit 4 determines the temporal sequence of execution of work orders within given periods for the machine 2, for which the energy needs is at a minimum.

Within the next process steps, a reference point 12 is set in the production system in order to determine the geometric arrangement relationships of the machine 2 and supply equipment 3. Thereafter, the expected energy balance for each period for the machine 2 and the supply equipment 3 as well as the predictable values for energy consumption for overcovered or undercovered periods are determined. As a result, a media-dependent connection structure is formed which connects the machine 2 to the temperature regulating device 8b through the media line with a shut-off valve 15, and connects the temperature regulating device 5a of the machine 2 by a media line, in which the shut-off valve 13 is integrated, with the energy storage unit 10, as well as connects the temperature regulating device 5a of the machine 2 by a media line, into which the shut-off valve 14 is integrated, to an energy conversion unit 11. The energy storage unit 10 is connected by a media line, in which the shut-off valve 16 is integrated, with the energy conversion unit 11.

On this basis, there is an examination by the energy control unit 6 of whether, with the use of the determined combining structure, the expected values for energy consumption for overcovered or undercovered periods, respectively, differ by more than five percent. For such a relationship, an additional media-specific energy storage unit 10 is determined and included in the arrangement relationships with a minimum length of the media line. Further, the energy control unit 6 determines the energy needs depending upon outside temperature of the energy supply equipment 3 for each medium and period as well as excess energy for each medium and period from the sequence of execution of the work orders of the machine 2, and a media-specific energy exchange is undertaken between the machine 2 and the supply equipment 3 in such a way that the overall energy needs of the production system 1 is at a minimum.

The following process step is characterised by the fact that through the energy control unit 6 the outside temperature-dependent need for energy of the supply equipment 3 is determined for each medium and period as well as the excess energy for each medium and period from the previously planned sequence of execution of the work orders of the machine 2 and this previously planned sequence of execution is corrected in such a way that the total energy requirement of the production system 1 is minimised.

For the production system 1, by the energy control unit 6 period-dependently representative load use classes from the load spectra with consideration of their time rate per period are formed, and to these load use classes media-dependent energy excesses are assigned as well as, following, on the energy excesses calculated in such a way, the expected period-dependent values for maximum energy recycling for each medium are determined. Finally, the energy control unit 6 forms an energy balance value in the form of a differential value between the expected media-dependent energy excesses and the values for maximum energy recycling. The assessment is made in a way that the energy control unit 6 carries out the determination of the cost potential for remaining energy balance values by querying the energy planning unit 7. Thereafter, an energy conversion unit 11 is determined and is connected to the media-dependent connection structure.

### Reference Numerals List

1 production system

2 machine

3 supply equipment

4 planning unit

5a temperature regulating device of the machine

5b temperature regulating device of the machine

6 energy control unit

7 energy planning unit

8a temperature regulating device of the supply equipment

8b temperature regulating devise of the supply equipment

9 drive unit of a machine

10 energy storage unit

11 energy conversion unit

12 reference point

13 shut-off valve of the media line between the temperature regulating device 5a of the machine and energy storage unit 10

14 shut-off valve of the media line between the temperature regulating device 5b of the machine 5b and energy conversion unit 11

15 shut-off valve for the media line between machine 2 and temperature regulating device 8b of the supply equipment

16 shut-off valve for the media line between energy storage unit 10 and energy conversion unit 11

A work order

A_{fp} work orders (f) for period (p)

E energy needs

E_{gs} total energy needs (g) of a production system (s)

Ē_{gs} averaged total energy needs (g) of a production system (s)

Eₖ energy needs of a machine (k)

Ēₖ averaged energy needs of a machine (k)

E_{kTrepLrep} averaged energy needs of a machine (k) with a representative work area temperature (Tᵣₑₚ) and representative load spectrum (Lᵣₑₚ)

Eₐ energy needs of a drive (a)

Ēₐ averaged energy needs of a drive (a)

E_{kf} energy need of a machine (f) for implementation of a work order (f)

Eₕ energy needs of the supply equipment (h)

Eₕₘₚ energy needs of the supply equipment (h) per medium (m) and period (p)

E_{bp} energy balance (b) for a period (p)

Ēᵣₖₘₗ averaged energy recycling value (r) of a machine (k) for a medium (m) and load spectrum (l)

E_{Ükmp} energy excess of a machine (k) for medium (m) and period (p)

pₘ pressure of the medium (m)

Vₘ volume stream of the medium (m)

L load spectrum

Lᵣₑₚ representative load spectrum (rep)

tₗ time section for a load spectrum (l)

tₜᵣₑₚₖₗ time section (t) to achieving a representative work area temperature (rep) (r) of a machine (k) for a load spectrum (l)

Tₘ temperature of the medium (m)

Tᵣₖ work area temperature (r) of a machine (k)

Tᵣₑₚᵣₖ representative (rep) work area temperature (r) of a machine (k)

Tᵤ environmental temperature (u)

T_{g} lower temperature limit value (g)

Tₒ upper temperature limit value (o)

Tₛ temperature target value (s)

T_{erwT} expected (erw) outside temperature (T)

C energy storage capacity

Cₘₐₓ maximum energy storage capacity

C_{gt} energy storage capacity of an energy storage unit (g) for the time period (t)

□_{bt} effectiveness range for an energy storage unit (g) for a time period (t)

K_{gm} energy costs for a period (p) and medium (m)

Z_{f} work series for work order (f)

Kᵣₑₚₑₛ representative capacity class (e) for a production system (s)

1-12. (canceled)

13. A method for reducing energy input during operation of a production system having machines and supply equipment with determinable energy demands and energy planning units for work orders to be implemented in the machines, which comprises the steps of:
determining energy-related parameters of the machines and classifying the energy-related parameters into representative load spectra being classes of operating states of the machines via an energy control unit;
assigning expected average energy recovery values to the representative load spectra media-dependently;
determining respective time fractions for the load spectra based on time periods for the work orders and machine combinations by a planning unit;
determining, via the energy control unit, energy needs for each appropriate one of the machines for implementing a work order; and
assigning, via at least one of the energy control unit or the planning unit, the work orders to a machine, which shows lowest energy needs value in comparison to other ones of the machines.

14. The method according to claim 13, which further comprises determining at least one of energy needs of drives, media pressures to be provided, media volume streams, or temperatures to be set as the energy-relevant parameters of the machines.

15. The method according to claim 13, wherein the energy control unit stores determined energy needs for each of the machines to implement a work order and constructs a priority sequence in accordance with respectively calculated energy needs.

16. The method according to claim 13, which further comprises determining, via one of the energy control unit or the planning unit, periods with energy-intensive work orders of the production system, the energy planning unit performing a period-dependent energy cost comparison, and thereafter, the energy control unit or the planning unit controls a time-related sequence of execution of the work orders such that the energy-intensive work orders are performed in periods with low energy costs.

17. The method according to claim 13, which further comprises:
determining via the energy control unit the energy needs dependent upon outdoor temperatures of the supply equipment for each medium and period;
determining excess energy for each medium and period from a previously planned sequence of execution of the work orders for each of the machines; and
providing at least one of a media-specific energy exchange between the machines or the machines and the supply equipment in such a way that total energy needs of the production system is at a minimum.

18. The method according to claim 13, which further comprises:
determining, via the energy control unit, the energy needs dependent upon outside temperatures of the supply equipment for each medium and period; and
determining excess energy for each medium from a previously planned sequence of execution of the work orders for each of the machines and correcting a previously planned work series of the work orders in such a way that total energy needs of the production system is at a minimum.

19. The method according to claim 13, wherein energy stored in an energy storage unit is connected with a minimum length of a media line for media transfer to at least one of the machines or the supply equipment to the production system.

20. The method according to claim 19, wherein the energy storage unit is connected to an energy conversion unit, in which stored energy is converted to another kind of energy.

21. An apparatus for implementing a method for reducing energy input during operation of a production system having machines and supply equipment with determinable energy demands and energy planning units for work orders to be implemented in the machines, the apparatus comprising:
shut-off means;
data and control lines; and
an energy control unit being connected to elements of the production system by means of said data and control lines, said energy control unit being able to determine energy-related parameters of the machines continuously and to assign them to classes of operating states of the machines, said energy control unit connected with at least one of the energy planning units of the production system or an energy control unit of a power plant on a wireless basis, an internal network basis, the Internet, or in accordance with a scheme as dictated by said energy control unit, whereby a connection can be separated by said energy control unit by means of said shut-off means.

22. The apparatus according to claim 21, further comprising:
media lines; and
shut-off valves disposed in said media lines, the machines and the supply equipment are connected by said media lines having said shut-off valves, constructing a media-dependent connection structure.

23. The apparatus according to claim 22, wherein said media-dependent connection structure includes an energy storage unit.

24. The apparatus according to claim 22, wherein said media-dependent connection structure includes an energy conversion unit.
